(19) United States
(12) Patent Application Publication
(10) Pub. No.: US 2003/0029994 A1
(43) Pub. Date: Feb. 13, 2003

(54) Method for determining metal ions and apparatus for implementing the same

(76) Inventor: Dong K. Jung, Kyunggi-do (KR)

Correspondence Address: OSTROLENK FABER GERB & SOFFEN, 1180 AVENUE OF THE AMERICAS, NEW YORK, NY, 100368403

(21) Appl. No.: 09/728,126

(22) Filed: Dec. 1, 2000

(30) Foreign Application Priority Data
Dec. 10, 1999 (KR) 99-56755

(51) Int. Cl. H01J 49/00; B01D 59/44

(52) U.S. Cl. 250/283

(57) ABSTRACT

Disclosed is a novel method for determining metal ions and an apparatus for implementing the same. A first sample containing luminol and hydrogen peroxide and a second sample containing a metal ion are independently introduced into a predetermined space. The first and second samples introduced into the predetermined space at the same time move along a channel simultaneously in the predetermined space in order to start a reaction between them and emit light. The intensity of the emitted light is measured to determine the concentration of the metal ion. The concentration of trace amounts of the metal ion can be accurately determined by utilizing the apparatus of the present invention.

### BACKGROUND OF THE INVENTION

1. Field of the Invention

The present invention relates to a method for determining metal ions and an apparatus for implementing the same, and more particularly, to a method for quantitatively determining trace amounts of metal ions and an apparatus for advantageously implementing the same.

2. Description of the Related Art

Conventionally, spectroscopic methods such as AAS (atomic absorption spectroscopy), ICP-AES (inductively coupled plasma-atomic emission spectroscopy) and ICP-MS (inductively coupled plasma-mass spectroscopy), are commonly utilized for analyzing metal ions contained in an inorganic sample. However, the expense of maintaining the instruments are high and safety is difficult to maintain because of the utilization of flame or high temperature plasma which accompany these methods. In addition, the instruments themselves are very expensive and are difficult to operate. To overcome these problems, various emission spectroscopic methods having excellent sensitivities and low determination limits are utilized. Among the emission spectroscopic methods, chemiluminescence analysis have drawn many attentions.

Luminescence is generally defined by emission of absorbed energy. Sometimes, the emitted light itself is called luminescence. Luminescence is classified into light luminescence, X-ray luminescence, electric field luminescence, thermal-luminescence, chemiluminescence, fermentative luminescence, and the like according to the kind of stimulation. Typically, an energy-absorbed electron system emits light when an electron transits from an excited state of high energy level to a ground state of low energy level. Sometimes, electron transition occurs through an intermediate step, and the wavelength, fluorescence and afterglow of the emission spectrum reflects the nature of the electron state of a material. Alternately, luminescence is classified as fluorescence and afterglow, commonly it is referred to as fluorescence.

Chemiluminescence analysis is a method generally utilized for determining the light emitted from the material of the excited state of which energy has been absorbed from a chemical reaction. Most of the organic compounds are oxidized while exhibiting a weak chemiluminescence. Especially, nitrogen-containing polycyclic compounds such as luminol, lucigenin, lophine, and the like exhibit strong bluish green chemiluminescence. Most of the known chemiluminescence until now are accompanied by an oxidation reaction in an alkaline solution. The color of the chemiluminescence is blue, celadon green, bluish green, etc. and the spectrum is in the visible region with a maximum peak at 400-500 nm.

As a typical example of chemiluminescence, luminol(5-amino-2,3-dihydro-1,4-phthalazindion) can be illustrated, which is white crystal and has melting point of 319-320 C. Luminol is known to exhibit the strongest emission of chemiluminescence as well as lucigenin, and is prepared by reducing 3-nitrophthalic acid hydrazide which is obtained by reacting 3-nitrophthalic acid anhydride with hydrazine. Its aqueous solution is alkaline and shows blue-colored chemiluminescence when oxidized by oxygen, ozone, hydrogen peroxide, hypocharchloric acid salt, etc. The emission intensity is particularly high when luminol is oxidized by hydrogen peroxide in the presence of Fe(II) ion. The emission spectrum of the chemiluminescence of the luminol alkaline solution is found at 350-600 nm region with the maximum peak of about 426 nm, although a slight different result could be obtained according to the solvent utilized. The chemiluminescence of the luminol is connected with the fluorescence of 3-aminophthalic acid ion which is the final product of the oxidation of luminol.

Various methods for determining metals such as copper, cobalt, iron and chrome have been reported. Among them, a method utilizing the intensity of chemiluminescence with respect to the change of the concentration of trace amounts of a specific metal ion which is added as a catalyst in an oxidation reaction of luminol by hydrogen peroxide, is widely used. When excess amounts of luminol and hydrogen peroxide are added, the emission intensity of the chemiluminescence is proportional to the concentration of a metal ion. Accordingly, this method is utilized for analyzing trace amounts of metal ions such as Cr(III), Mn(II), Fe(II), Co(II), Ni(II), Cu(II), etc. In the alkaline solution, oxygen rapidly oxidizes, for example, Fe(II) to ferric hydroxide. The oxidation mechanism of aqueous luminol solution is not yet accurately verified. However, it is considered that an intermediate compound of Fe(II) obtained by dissolved oxygen reacts with luminol.

As described above, the analysis of the metal ion added as a catalyst in the chemiluminescence analysis utilizing luminol is rapid, sensitive and economical in that expensive equipments are not needed. Hence, it is very advantageous. However, the influence of the metal ion to the chemical reaction of the luminol depends on pH of the solution, the presence of hydrogen peroxide, the kind of buffer solution utilized, the presence of oxygen, the kind of the metal ion, etc. Accordingly, these factors should be appropriately combined to set an optimized condition. Under the optimized condition, a standard reference graph is made by the relationship of the concentration of the metal ions with respect to the intensity of the chemiluminescence. Then, the intensity of the chemiluminescence of an unknown sample is measured to determine the concentration of the metal ions in an unknown sample by utilizing the standard reference graph.

Recently, some metal ions contained in a chemical species generate chemiluminescence in an aqueous luminol solution without hydrogen peroxide. Fe(II), Fe(CN)₆³⁻, MnO₄⁻, AuCl₄⁻, SbCl₆⁻, V(IV), V(II), etc. can be exemplified. Among the metal ions, the reaction between luminol and Fe(II) is the most widely studied. However, maximum peak of the chemiluminescence may not be obtained without hydrogen peroxide, thus, the addition of hydrogen peroxide is preferable.

The analyzing method for the metal ions utilizing the chemiluminescence emitted during the oxidation of luminol will be explained in detail below.

FIG. 1 is a cross-sectional view of a cell employed in the conventional apparatus for determining the metal ions. A cell 10 has a reaction vessel 12 which is, for example, made from borosilicate glass, of which height is 2 cm and of which outer diameter thereof is 12 mm. Three sample introducing tubes 13a, 13b and 13c of which diameters are, for example, 3 mm, are provided at the bottom portion of reaction vessel 12, and a sample exhausting tube 18 is provided at the upper portion of reaction vessel 12. To two sample introducing tubes 13b and 13c, sample injecting tubes 14b and 14c are respectively connected. To the remaining sample introducing tube 13a, an air injecting tube 14a is connected. The arrow designated in reaction vessel 12 represents the main flow of the samples. Designation numeral 16 indicates air droplets of nitrogen, oxygen, etc. The method for determining the metal ions utilizing this cell will be described below.

First, luminol is dissolved in 0.01M KOH—H₃BO₃ buffer solution. Hydrogen peroxide is diluted into water to prepare hydrogen peroxide solution. A 0.100M standard Fe(II) solution is prepared by dissolving FeSO₄ in an acidic solution. Nitrogen gas is supplied through air injecting tube 14a and air introducing tube 13a and the prepared samples are supplied through sample injecting tubes 14b and 14c and sample introducing tubes 13b and 13c. The flow rates of the samples are controlled to, for example, about 4 m/min by means of syringe pumps.

At this time, the luminol solution and hydrogen peroxide solution are stored in respective storing containers. They are mixed just before introducing them into the reaction vessel and injected through sample injecting tube, for example, 14b. The Fe(II) solution is injected through the remaining sample injecting tube 14c.

The injected samples move upward by the applied force to the injecting direction and by the action of the air droplets, and then move downward along the arrow to be mixed and proceed reaction. Excess amount of sample is exhausted through the sample exhausting tube provided at the upper portion of the reaction vessel according to the injecting velocity of the samples. The emitted light generated during the reaction from the reaction vessel is amplified and then converted into current. The converted current is measured to determine the intensity of the emitted light. Based on the light intensity, the amount of Fe(II) can be determined.

However, because the reaction vessel has a cylindrical shape and a larger diameter than those of the sample introducing tubes, the reactants cannot be completely mixed prior being exhausted according to the above-described method. Further, a uniform light intensity cannot be obtained because firstly introduced sample is not firstly exhausted due to the structure of the cell. As a result, the light intensity of the firstly introduced sample affects the light intensity of the later introduced sample, causing the occurrence of memory effect.

In addition, the injected air droplets scatter the light emitted during the reaction to deteriorate the stability and reproductiveness of the measurement. Accordingly, although this apparatus can be advantageously utilized for a qualitative analysis, an accurate determination of the concentration of the metal ions is difficult, hence decreasing the reliability of quantitative analysis obtained from such apparatus.

### SUMMARY OF THE INVENTION

Accordingly, it is an object in the present invention considering the problems of the conventional technique, to provide a novel method for quantitatively determining metal ions to a low detection limit.

Another object of the present invention is to provide a method for applying the above-described method for determining the metal ions to a semiconductor manufacturing process.

Further another object of the present invention is to provide an economic apparatus for advantageously determining the concentration of metal ions, by which the retention time of the reagents utilized for the determination of the metal ions in a reaction vessel is increased, the reagents are completely mixed and the memory effect is eliminated to accomplish a sufficient reaction.

Further still another object of the present invention is to provide an apparatus having a high sensitivity and an excellent collection efficiency of the light emitted during the reaction procedure for determining metal ions.

To accomplish the object of the present invention, there is provided in the present invention a method for determining metal ions. A first sample containing luminol and hydrogen peroxide and a second sample containing metal ions are independently introduced into a predetermined space. Then, the first and second samples introduced into the predetermined space at the same time move simultaneously along a channel in the predetermined space in order to be mixed to start a reaction between them and emit light. A produced sample after completing the reaction is exhausted and the intensity of the emitted light is measured. The measured intensity is treated to determine the concentration of the metal ions.

Particularly, the solvent of the second sample containing the metal ions can be water, water-soluble and saturated alcohol of C₁-C₆ compounds or a mixture thereof. C₁-C₆ compounds means carbon compounds containing 1-6 carbons. As an example of the water-soluble and saturated alcohol, IPA (isopropyl alcohol) can be illustrated.

It is preferred that the emitted light is separately collected in order to maximize the collection efficiency of the emitted light. This can lower the detection limit of the metal ions.

The method of the present invention can be utilized to determine the concentration of the metal ions contained in IPA which is used as a rinsing solution in a semiconductor process, in an on-line method. That is, the IPA solution containing the metal ions can be directly analyzed to determine the concentration of the metal ions by directly introducing the IPA solution into the predetermined space to start the luminol oxidation.

Another object of the present invention can be accomplished by an apparatus for determining metal ions. The apparatus comprises a cell including two sample introducing tubes at a bottom portion of the cell, one sample exhausting tube at an upper portion of the cell and a pipe-shaped reaction tube of which diameter is 1-10 times of a diameter of the sample introducing tube. Emitted light passes the reaction tube while samples react in the reaction tube. The apparatus also includes a sensor for measuring an intensity of the emitted light and a controller for treating the measured intensity of the emitted light to obtain a concentration of the metal ions.

The apparatus preferably further comprises a collector having a hemispherical shape for wrapping the cell and a holder for supporting the collector. A reflection layer is formed on an inner surface of the collector. The holder includes three holes for passing the sample introducing tubes and the sample exhausting tube. The holder is made from a dielectric material.

Preferably, the cell and the collector are made from quartz or sapphire and the reflection layer is an aluminum layer or a silver paper.

The apparatus may further comprise an amplifier for amplifying the collected light, a current converter for converting the amplified light into current and at least one syringe pump for introducing the samples into the reaction tube through the sample introducing tubes. In addition, the cell, the collector and the holder are preferably provided in a dark enclosure for shielding an external light.

The introduced samples proceed along the reaction tube toward the sample exhausting tube. Therefore, the samples are advantageously mixed and completely reacted prior to being exhausted, and thus the light emission accompanied by the reaction is also completely emitted within the reaction tube. After the completion of the light emission, the product of the introduced samples are exhausted through the sample exhausting tube. The pipe-shaped reaction tube is installed in a predetermined space in an appropriate structure. At this time, if the reaction tube occupies too wide space or is arranged too long, the measurement of the emitted light becomes difficult. Therefore, as long as possible reaction tube is preferably installed in the predetermined space such that it is integrated in a space narrow as possible.

For example, the reaction tube may have a circularly integrated helical structure. Then, the samples proceed along the reaction tube having the helical structure while rotating. Therefore, the samples can be advantageously mixed without any separate mixing means. The reaction tube may have an appropriate structure such as a zig-zag shape or an irregularly interwound structure considering the problems of the sample mixing and the manufacturing thereof.

In the method of the present invention, the samples introduced for the luminol reaction are sufficiently mixed and proceed the reaction in the reaction tube and then, the reaction product is exhausted out. In addition, the samples flow in serial order, that is, firstly introduced samples are exhausted first and subsequently introduced samples are exhausted according to the order of their introduction. Accordingly, the amount of the metal ions can be quantitatively determined by utilizing the emitted light, and accurate concentration of the metal ions such as Fe(II), Cu(II), Cr(II) and Co(II) can be determined by the method of the present invention. Particularly, the concentration of the metal ions in the range of 0.01-5.00 ppm by weight can be accurately determined, further, the determination limit of the concentration is in the range of from hundreds ppt to several ppb by weight.

Meantime, according to the apparatus of the present invention, the retention time of the samples in the reaction tube is largely increased and so a sufficient time for the completion of the mixing and reaction of the samples can be accomplished.

### BRIEF DESCRIPTION OF THE DRAWINGS

The above objects and advantages of the present invention will become more apparent by describing in detail preferred embodiments thereof with reference to the attached drawings, in which:

FIG. 1 is a cross-sectional view of a cell employed in a conventional apparatus for determining metal ions for explaining the conventional method for determining the metal ions;

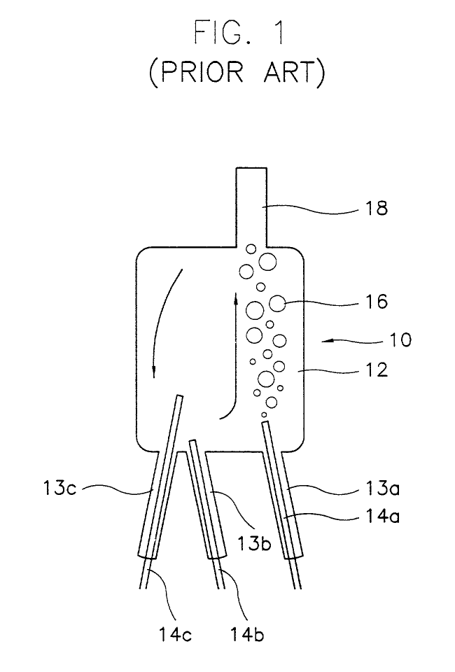

FIG. 2 is a cross-sectional view of a cell employed in an apparatus for determining metal ions according to the present invention;

FIGS. 3A & 3B are a bottom view and a top view of the cell illustrated by FIG. 2;

FIGS. 4A & 4B are a perspective view and a side view of the cell illustrated by FIG. 2 installed in a light collector;

FIG. 5 is a constitutional view of an apparatus for determining metal ions according to the present invention;

FIG. 6 is a flow chart for explaining a method for determining metal ions according to the present invention;

FIG. 7 is a graph obtained by analyzing a sample utilizing water as a solvent according to a method of the present invention;

FIG. 8 is a graph obtained by analyzing a sample utilizing 10% IPA as a solvent according to a method of the present invention;

FIGS. 9A & 9B are graphs obtained by analyzing a sample utilizing 50% IPA as a solvent according to a method of the present invention; and

FIGS. 10A & 10B are graphs obtained by analyzing a sample utilizing 100% IPA as a solvent according to a method of the present invention.

### DESCRIPTION OF THE PREFERRED EMBODIMENT

A preferred embodiment of an apparatus for determining metal ions according to the present invention will be explained in detail with reference to the attached drawings. After explaining the apparatus, a method for determining metal ions according to the present invention will be described. However, it should be understood that the method of the present invention is not limited to the embodiment shown and described.

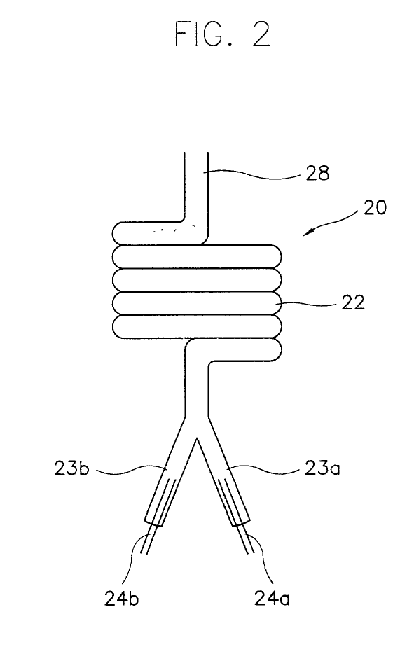

FIG. 2 is a cross-sectional view of a cell employed in an apparatus for determining metal ions according to the present invention.

A cell 20 includes a reaction tube 22, two sample introducing tubes 23a and 23b which form “Y” shape and a sample exhausting tube 28. Into sample introducing tubes 23a and 23b, sample injecting tubes 24a and 24b are respectively inserted. Cell 20 has a structure and dimensions as follows. The diameter a circle in a helical structure is in a range of 1.5-1.9 cm, the height of the helical structure is in a range of 1.9-2.3 cm, the diameter of reaction tube 22 is in a range of 3-50 mm and the diameter of the sample introducing tube is in a range of 3-5 mm.

Each sample is introduced through sample injecting tubes 24a and 24b and sample introducing tubes 23a and 23b, and then flows through reaction tube 22 which forms a circularly integrated structure having a predetermined diameter. Once, the samples are introduced into the reaction tube, a reaction is initiated.

Since the samples rotate and rise along the reaction tube, the samples are homogeneously mixed and the reaction between them is almost completely finished within the reaction tube. Therefore, the separate injection of air droplets for the homogeneous mixing of the samples as in the conventional method, is not needed in the present invention. In addition, since the reaction tube has an integrated structure of a very long pipe, the retention time of the samples is prolonged and firstly introduced sample is exhausted firstly.

When the introducing velocity of the sample containing luminol and hydrogen peroxide is 1-5 m/min and the introducing velocity of the sample containing metal ions is 1-10 m/min, the retention time of the samples in the cell is about 30 seconds and more. During this retention time, 99% of the oxidation of luminol is completed.

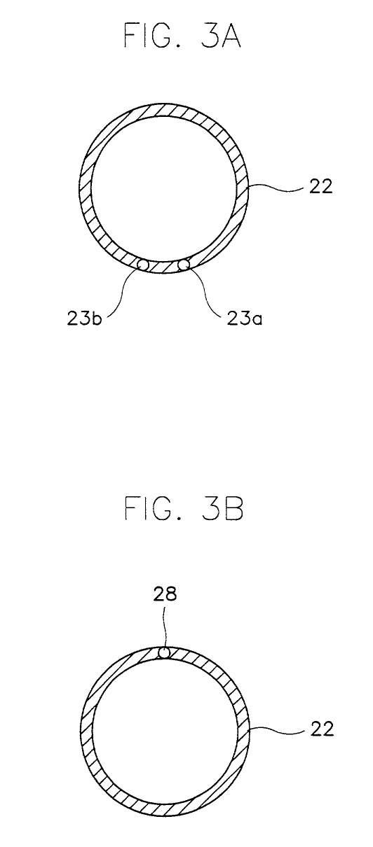

FIGS. 3A & 3B are a bottom view and a top view of the cell illustrated by FIG. 2. Sample introducing tubes 23a and 23b, and sample exhausting tube 28 are formed on the opposite positions with respect to the center of the circle which is obtained by integrating reaction tube 22. This structure facilitates somewhat the mixing of the samples. However, the tubes could be formed at any positions.

During the oxidation of luminol with a metal ion catalyst in the cell, it is recommended that the total amount of the emitted light can be collected, if possible. However, practically, this is difficult. The collector is provided around the cell in the present invention in order to collect as much as possible amount of light.

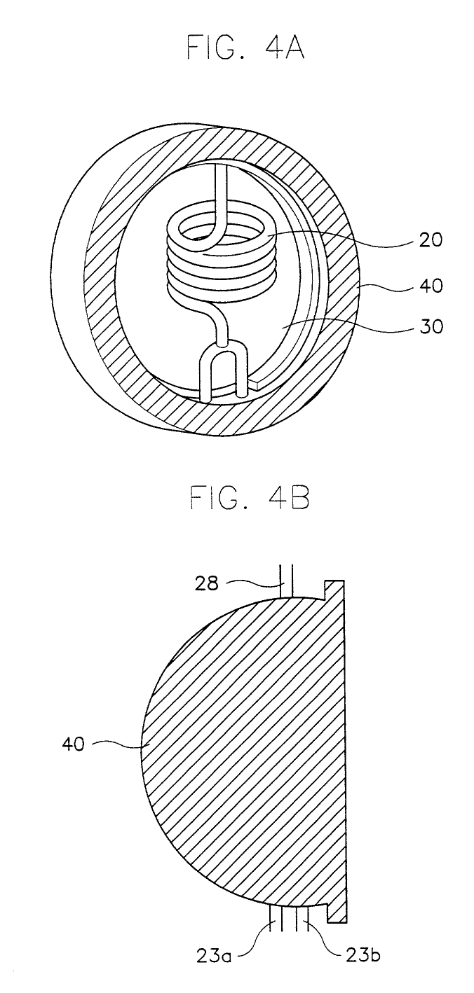

FIGS. 4A & 4B are a perspective view and a side view of the cell illustrated by FIG. 2 installed in a light collector. Around cell 20, a collector 30 having a hemispherical shape for wrapping cell 20 and a holder 40 for supporting collector 30 are provided. At upper and bottom portions of holder 40, three holes are formed for passing sample exhausting tube 28 and sample introducing tubes 23a and 23b.

Cell 20 and collector 30 are preferably formed from quartz for maximally passing the emitted light from the reaction tube. At the inner surface of collector 30, a reflecting layer is formed for collecting incident lights and reflecting it toward one direction. As for the reflecting layer, an aluminum layer or a silver paper is preferably used. Neighboring an amplifier for amplifying the light, holder 40 is preferably formed from the dielectric material. Further, the preferred color of holder 40 is black for preventing the leakage of the emitted light from the reaction tube and for blocking an incidence of external light.

Particularly, the incidence of external light into the cell should be prevented and this can be achieved by installing the holder in which the cell and collector are provided, and installing the amplifier neighboring the holder into a dark enclosure of a separately manufactured case. Further, it is preferred that the sample injecting tubes, the sample introducing tubes and the sample exhausting tube are wrapped by a light shielding material in order to prevent the incidence of external light.

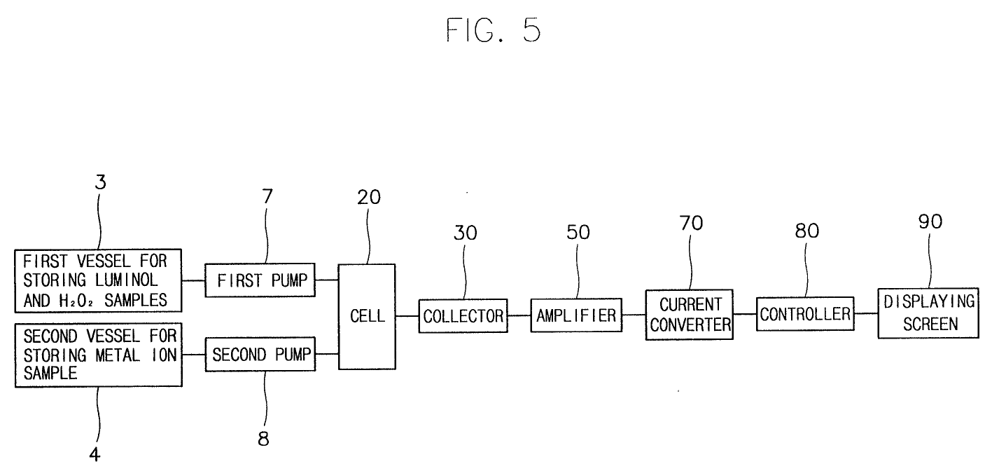

FIG. 5 is a constitutional view of the apparatus including the cell, the collector and the holder for determining the metal ions according to the present invention. First, a luminol sample and a hydrogen peroxide sample are prepared and stored in a first vessel 3 and a metal ion sample is prepared and stored in a second vessel 4. A first and a second pumps 7 and 8 are respectively provided with first and second vessels 3 and 4 for injecting the samples into cell 20 in predetermined velocities. Preferably, the luminol sample and the hydrogen peroxide sample are separately prepared and stored and mixed just before being injected into the reaction tube. Alternately, they can be mixed in an appropriate mixing ratio and stored in one vessel and the stored mixture is injected into the reaction tube.

Collector 30 is provided around cell 20 and amplifier 50 is near to collector 30. The section of the hemisphere of collector 30 and a light receiving portion of amplifier 50 adhere closely. At the light receiving portion, a light sensor for measuring the light is provided and then, the sensed light is amplified. A current converter 70 for converting the collected and amplified light into current signals, a controller 80 and a displaying screen 90 are sequentially provided. Controller 80 treats the inputted current signals to obtain the concentration of the metal ions and to display thus obtained result on screen 90. In addition, controller 80 controls the voltage applied to amplifier 50.

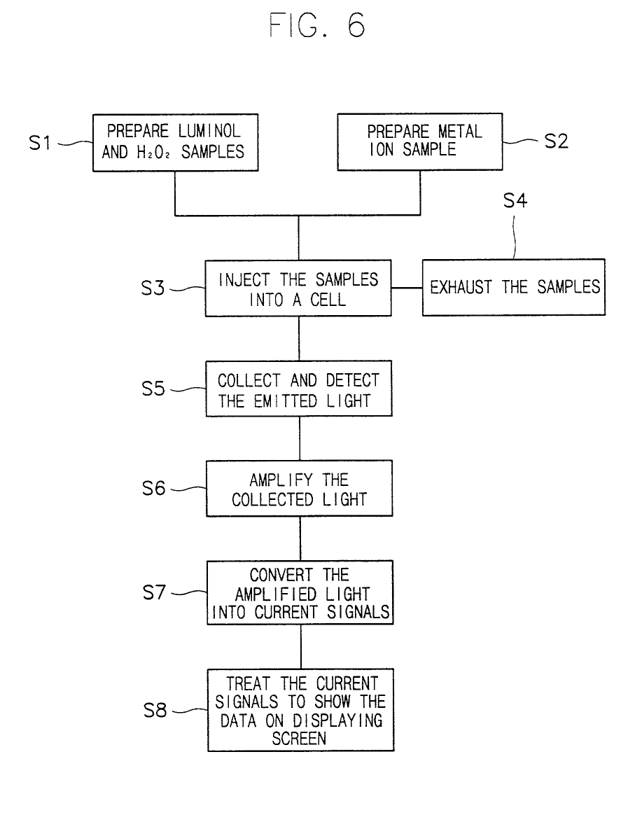

FIG. 6 is a flow chart for explaining a method for determining metal ions according to the present invention utilizing the above-described apparatus.

First, a luminol sample, a hydrogen peroxide sample and a metal ion sample are prepared and stored in separate containers at step S1 and S2. The prepared samples are injected into the cell at predetermined velocities by utilizing the syringe pump or a geared pump at step S3 to start a continuous oxidation of the luminol. Since a certain amount of the samples is continuously injected into the cell, the same amount is exhausted. The samples sequentially proceed along the reaction tube provided at the apparatus of the present invention, while being sufficiently mixed and implementing the reaction. As a result, almost all the amount of the injected samples react and exhaust as a resulting product at step S4.

The light emitted during the reaction is collected at step S5 and detected. Then, the light is amplified at step S6 and converted into current signals at step S7. The current signals are treated to obtain the concentration of the metal ions and the result is displayed on a screen at step S8.

Practically, in order to obtain an accurate concentration analysis of the metal ions, all the conditions such as the solvent, the pH of the solution, the concentration of the luminol sample, the injecting condition, and the like should be kept constantly. The light intensities are measured with respect to the changes of the concentration of the metal ions to obtain a standard reference curve illustrating the relation between the light intensity and the concentration of the metal ions. Based on the standard reference curve, the concentration of the metal ions in an unknown sample is obtained.

The preferred embodiments of the present invention will be described in detail below. In the embodiments, the method for obtaining the calibration curves under several conditions while changing the concentration of Fe(II), is explained.

In the embodiments, 18M deionized water was used, which has been prepared by utilizing a deionizing system of Barnstead company. The cell illustrated by FIG. 2 was manufactured. The diameter of the circle made by the integrated reaction tube was 1.7 cm and the height thereof was 2.1 cm. The diameter of the reaction tube was 7 mm and the diameter of the sample introducing tube was 4 mm. PMT (photomultiplier) was utilized as the amplifier and a picoammeter of Keithley Co. having 486 autoranging was utilized as the current converter. The luminol sample and the hydrogen peroxide sample were injected by utilizing a gear pump of Jovin-yvon Co. and the metal ion sample was injected by utilizing a syringe pump of KASP 005/150MT PTFE of Gun-A Electric Motor Co. Luminol from Sigma-Aldrich Co., Ltd. was used.

### EXAMPLE 1

Luminol was converted into its sodium salt and recrystallized in an aqueous alkaline solution for the purification. The concentration of H₃BO₃ was kept constant while changing the amount of KOH to prepare 0.1M KOH—H₃BO₃ buffer solution of which pH was 11. The purified luminol was dissolved in the KOH—H₃BO₃ buffer solution so that the concentration of the luminol was 0.01M. 1 g of FeSO₄ was dissolved into 1000 g of water to prepare a storing solution. A portion of this storing solution was taken and diluted to prepare a standard Fe(II) solution of 0.01 ppm by weight.

Into the cell, solvent was injected first. Then, the luminol sample and the hydrogen peroxide sample were injected into the cell at the velocity of 1.3 m/min according to the rotational number of the gear pump. The metal ion sample was injected into the cell at the velocity of 5 m/min by utilizing the syringe pump. The light emitted from the cell was collected and then amplified by PMT which is operated at 500V. The amplified light was converted into current by the picoammeter and the converted current data were treated to measure the light intensity. The above-described procedure was repeated 5 times and thus obtained result is illustrated in Table 1.

### EXAMPLES 2-5

The same procedure described in Example 1 was implemented except that standard Fe(II) solutions of 0.05 ppm, 0.10 ppm, 2.50 ppm and 5.00 ppm were prepared and utilized for the corresponding examples. The same procedure was repeated 5 times for each concentration of the metal ion and thus obtained result is illustrated in Table 1.

### EXAMPLES 6-10

The same procedures described in Examples 1-5 were implemented except that a mixture of 90% by weight of water and 10% by weight of IPA was used as the solvent containing the metal ion instead of water. The result is illustrated in Table 2.

### EXAMPLES 11-15

The same procedures described in Examples 1-5 were implemented except that a mixture of 50% by weight of water and 50% by weight of IPA was used as the solvent containing the metal ion instead of water. The result is illustrated in Table 3.

### EXAMPLES 16-20

The same procedures described in Examples 1-5 were implemented except that IPA was used as the solvent containing the metal ion instead of water. The result is illustrated in Table 4.

### COMPARATIVE EXAMPLES 1-4

The same procedures described in Examples 1-4 were implemented except that the solvents not containing the metal ion were utilized as the metal ion samples. The results are illustrated in Tables 1-4 for the concentration of the metal ion of 0.00 ppm. In the tables, conc. means the concentration of the metal ion in ppm by weight, s. d. means standard deviation and r. s. d. means relative standard deviation.

TABLE 1
Water was used as the solvent of the metal ion sample

| No. conc. | 0.00 | 0.01 | 0.05 | 0.10 | 2.50 | 5.00 |
|---|---|---|---|---|---|---|
| 1st | 6.23E−11 | 1.21E−09 | 2.81E−09 | 3.80E−09 | 6.40E−08 | 1.10E−07 |
| 2nd | 6.23E-11 | 1.21E−09 | 2.76E−09 | 4.15E−09 | 6.62E−08 | 1.13E−07 |
| 3rd | 6.19E-11 | 1.20E−09 | 2.68E−09 | 4.08E−09 | 6.59E−08 | 1.11E−07 |
| 4th | 6.22E-11 | 1.25E−09 | 2.68E−09 | 4.14E−09 | 6.50E−08 | 1.13E−07 |
| 5^{th} | 6.24E-11 | 1.19E−09 | 2.80E−09 | 4.02E−09 | 6.38E−08 | 1.12E−07 |
| mean | 6.22E-11 | 1.21E−09 | 2.75E−09 | 4.04E−09 | 6.50E−08 | 1.12E−07 |
| s.d. | 1.66E-13 | 2.32E−11 | 6.11E−11 | 1.45E−10 | 1.08E−09 | 1.32E−09 |
| r.s.d.(%) | 0.267 | 1.913 | 2.225 | 3.593 | 1.665 | 1.187 |

TABLE 2
A mixture of 90% by weight of water and 10% by weight of IPA was
used as the solvent of the metal ion sample

| No. conc. | 0.00 | 0.01 | 0.05 | 0.10 | 2.50 | 5.00 |
|---|---|---|---|---|---|---|
| 1st | 1.26E−11 | 2.82E−11 | 2.86E−10 | 6.29E−10 | 3.32E−08 | 5.89E−08 |
| 2nd | 1.47E−11 | 2.87E−11 | 2.70E−10 | 6.38E−10 | 3.72E−08 | 5.74E−08 |
| 3rd | 8.66E−12 | 3.00E−11 | 3.18E−10 | 6.41E−10 | 3.40E−08 | 5.84E−08 |
| 4th | 8.37E−12 | 3.09E−11 | 2.62E−10 | 6.60E−10 | 3.35E−08 | 6.30E−08 |
| 5^{th} | 8.42E−12 | 3.21E−11 | 2.67E−10 | 6.63E−10 | 3.28E−08 | 5.91E−08 |
| mean | 1.05E−11 | 3.00E−11 | 2.81E−10 | 6.46E−10 | 3.41E−08 | 5.94E−08 |
| s.d. | 2.92E−12 | 1.61E−12 | 2.26E−11 | 1.48E−11 | 1.75E−09 | 2.15E−09 |
| r.s.d.(%) | 27.694 | 5.357 | 0.072 | 2.296 | 5.121 | 3.626 |

TABLE 3
A mixture of 50% by weight of water and 50% by weight of IPA was
used as the solvent of the metal ion sample

| No. conc. | 0.00 | 0.01 | 0.05 | 0.10 | 2.50 | 5.00 |
|---|---|---|---|---|---|---|
| 1st | 3.94E−11 | 1.25E−10 | 1.53E−10 | 1.30E−10 | 6.76E−09 | 1.49E−08 |
| 2nd | 4.07E−11 | 1.12E−10 | 1.61E−10 | 1.30E−10 | 6.92E−09 | 1.48E−08 |
| 3rd | 4.25E−11 | 1.19E−10 | 1.54E−10 | 1.31E−10 | 7.76E−09 | 1.37E−08 |
| 4th | 4.26E−11 | 1.23E−10 | 1.57E−10 | 1.19E−10 | 7.43E−09 | 1.42E−08 |
| 5th | 4.13E−11 | 1.20E−10 | 1.28E−10 | 1.23E−10 | 7.03E−09 | 1.38E−08 |
| mean | 4.13E−11 | 1.20E−10 | 1.51E−10 | 1.27E−10 | 7.18E−09 | 1.43E−08 |
| s.d. | 1.33E−12 | 4.97E−12 | 1.30E−11 | 5.32E−12 | 4.08E−10 | 5.54E−10 |
| r.s.d.(%) | 3.226 | 4.149 | 8.640 | 4.202 | 5.681 | 3.380 |

TABLE 4
IPA was used as the solvent of the metal ion sample

| No. conc. | 0.00 | 0.01 | 0.05 | 0.10 | 2.50 | 5.00 |
|---|---|---|---|---|---|---|
| 1st | 8.17E−12 | 2.74E−11 | 2.35E−11 | 3.06E−11 | 1.35E−10 | 2.84E−10 |
| 2nd | 8.13E−12 | 2.72E−11 | 2.41E−11 | 3.08E−11 | 1.53E−10 | 2.77E−10 |
| 3rd | 7.90E−12 | 2.69E−11 | 2.38E−11 | 3.11E−11 | 1.72E−10 | 2.73E−10 |
| 4th | 8.17E−12 | 2.61E−11 | 2.39E−11 | 3.86E−11 | 1.65E−10 | 2.41E−10 |
| 5th | 7.77E−12 | 2.64E−11 | 2.39E−11 | 4.02E−11 | 1.77E−10 | 2.62E−10 |
| mean | 8.03E−12 | 2.68E−11 | 2.38E−11 | 3.43E−11 | 1.60E−10 | 2.67E−10 |
| s.d. | 1.82E−13 | 5.42E−13 | 2.09E−13 | 4.73E−12 | 1.67E−11 | 1.69E−11 |
| r.s.d.(%) | 2.269 | 2.203 | 0.876 | 13.806 | 10.413 | 6.312 |

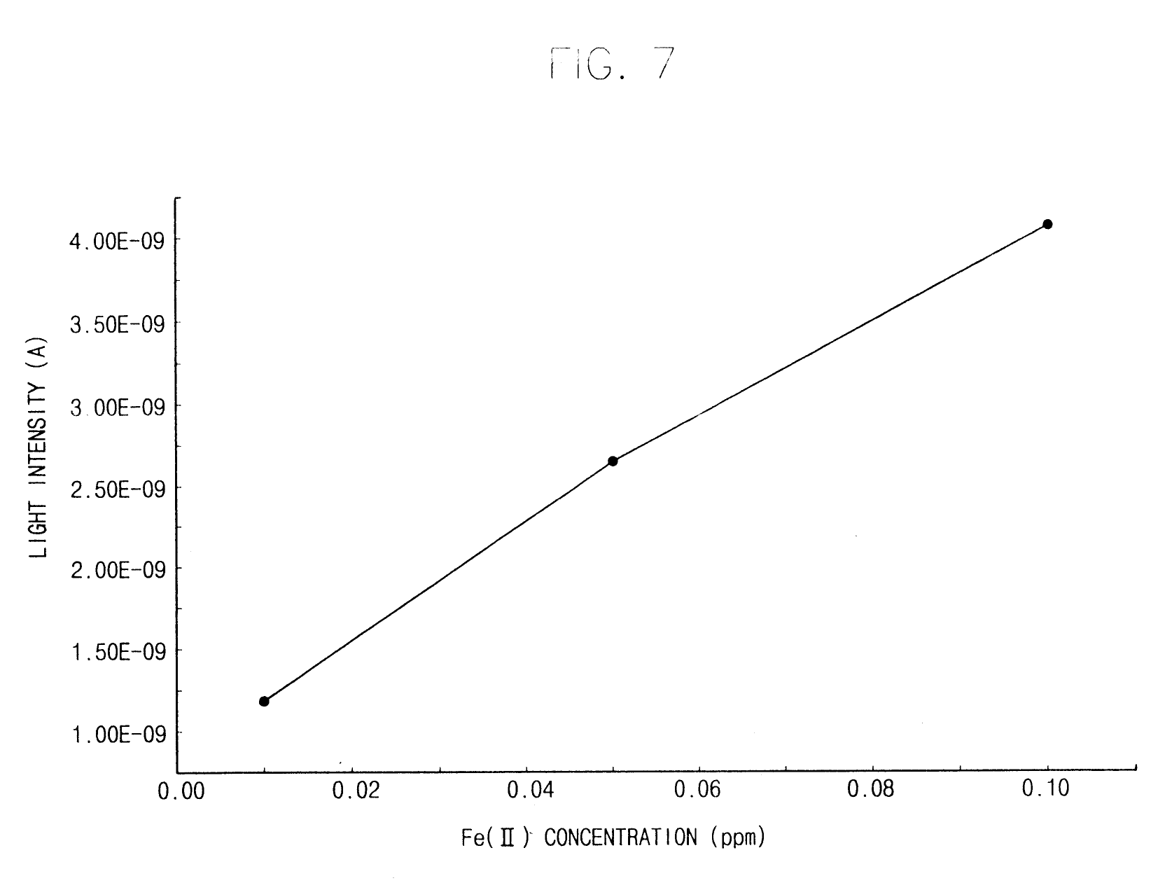

The results in Tables 1-4 are illustrated as graphs in FIGS. 7, 8, 9A, 9B, 10A and 10B.

FIG. 7 is a graph obtained by analyzing a sample utilizing water as a solvent according to the method of the present invention. The linearity of this graph was 0.9934 and the sensitivity was 3.1213E-08 A/ppb. The change in the light intensity is directly proportional to the change of the Fe(II) concentration, that is, the slope means the sensitivity. The steep slope indicates a high sensitivity, thus a little change of the concentration of the metal ion causes a large change in the light intensity.

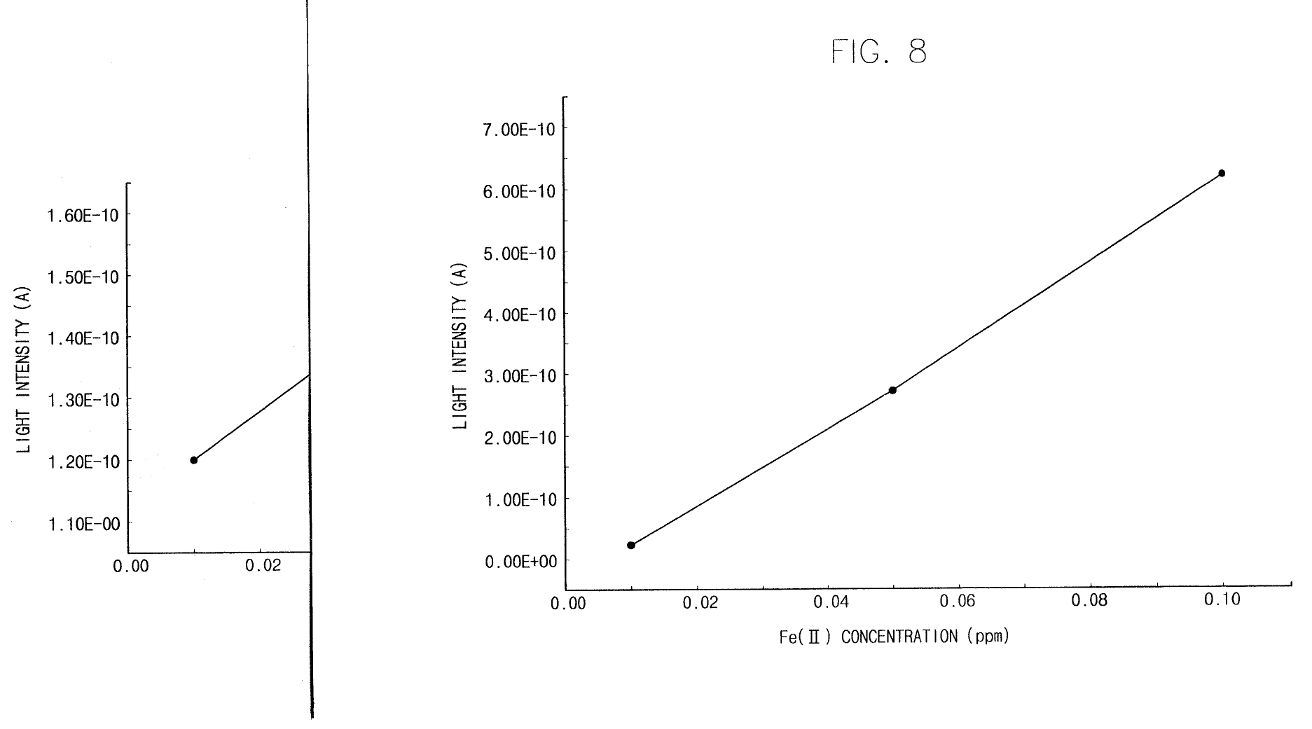

FIG. 8 is a graph obtained by analyzing a sample utilizing 10% IPA in water as a solvent according to the method of the present invention. The linearity of the graph was 0.9991 and the sensitivity was 6.8631E-09 A/ppb.

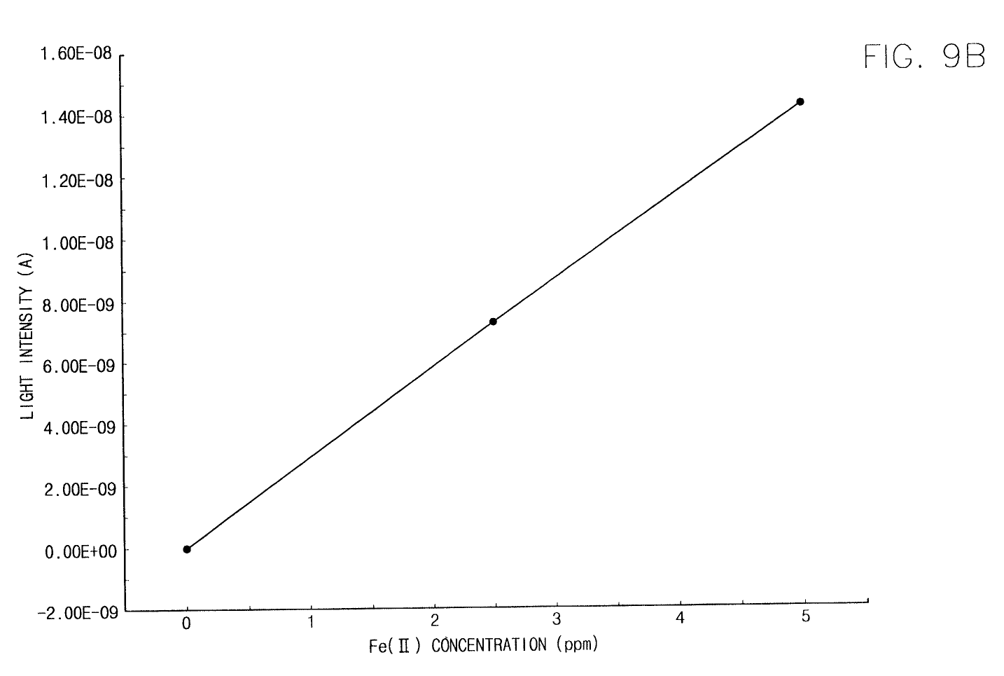

FIGS. 9A & 9B are graphs obtained by analyzing a sample utilizing 50% IPA in water as a solvent according to the method of the present invention. In FIG. 9B, the linearity of the graph was 0.9999 and the sensitivity was 2.8621E-09 A/ppb.

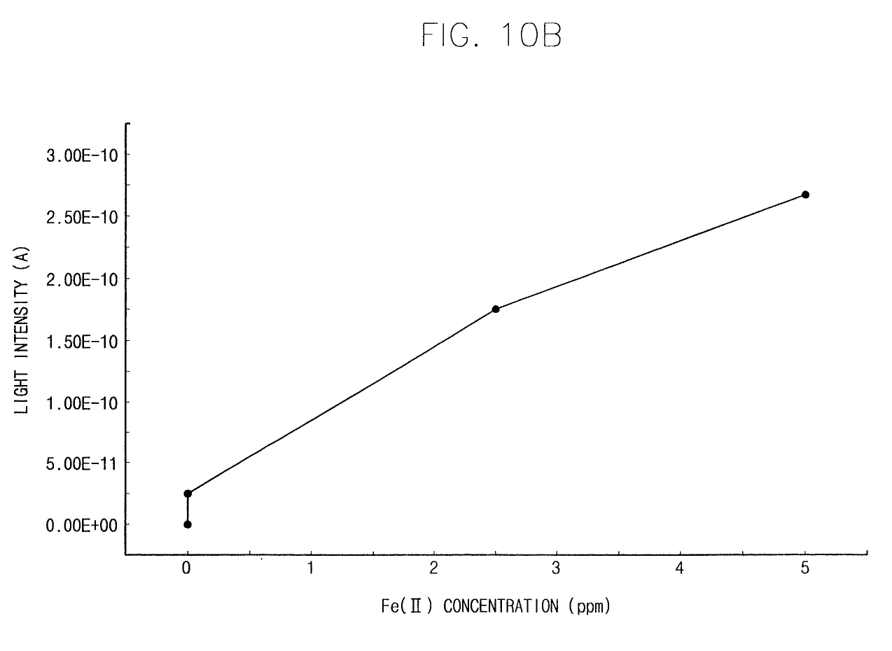

FIGS. 10A & 10B are graphs obtained by analyzing a sample utilizing 100% IPA as a solvent according to the method of the present invention. In FIG. 10A, the linearity of the graph was 0.9409 and the sensitivity was 7.8303E-10 A/ppb.

As illustrated in Tables 1-4 & FIGS. 7-10, the light intensities with respect to various concentrations were measured to obtain graphs. Based on these graphs, the concentration of unknown sample can be determined. Of course, the same cell should be utilized and other conditions should be the same.

From the result, it can be noticed that most satisfactory result can be obtained when water was utilized as the solvent. However, almost similar linearity or sensitivity are obtained when IPA or a mixture of water and IPA was used as the solvent and the results are sufficiently acceptable. This can be interpreted to have a very important practical application. That is, organic solvent can be utilized as the solvent of the metal ion instead of water. For the conventional cells, only water was used as the solvent.

Particularly, the apparatus of the present invention can be applied as an apparatus for determining the concentrations of the metal ions in various solutions exhausted from semiconductor manufacturing processes. IPA is used as a rinsing solution and solvent in the semiconductor process and the concentration of the metal ions contained in IPA as an impurity substance can be advantageously determined by the on-line system. Accordingly, an inexpensive, fast, sensitive and accurate method provided by the present invention can be applied for the determination of the impurity substance instead of the conventional AAS analysis method. The apparatus according to the present invention is simply installed at the portion where the solution containing IPA is exhausted after the implementation of the semiconductor process for each line. Then, the concentration of the metal ions in the IPA solution can be immediately determined and the acceptance or failure of the semiconductor process can be determined quickly to prevent any subsequent failures.

As an example of the semiconductor process, the following can be illustrated. For the manufacture of a semiconductor device, a photolithography process is applied for a number of times. The photolithography process requires an implementation of sequential processes of depositing a photoresist of which solubility changes by an exposure of light, drying, heating, exposing and then developing. After the developing process, a photoresist pattern can be obtained and the underlying layer is etched to manufacture a desired pattern. Thereafter, a stripping process is implemented to remove remaining photoresist while remaining the pattern of the underlying layer.

As for the developing solution utilized in the developing process, N-butyl acetate containing xylene are widely used for the negative photoresist and an alkaline solution containing potassium hydroxide or sodium hydroxide are widely used for the positive photoresist. For the commonly used positive photoresist, the velocity of the development can be controlled by the mixing ratio of the alkaline solution and water. However, potassium or sodium remaining on the wafer might affect particularly MOS device. Accordingly, the developing solution including 2-3% by weight of tetramethyl ammonium hydroxide or chlorine ammonium hydroxide in water can be preferably used for the device sensitive to potassium or sodium.

After the developing process, a rinsing process for cleaning the device is implemented and generally, the IPA solution is used as the rinsing solution. When the underlying layer to be etched by utilizing the photoresist pattern is a metal layer, the developing solution remaining after the developing process may generate a damage on the metal layer. And therefore, a clean rinsing of the remaining developing solution is needed. For this case, the concentration of the metal ions in the exhausting rinsing solution can be immediately determined by utilizing the apparatus of the present invention and the completion of the rinsing of the developing solution can be determined instantly.

In addition to the analysis whether the impurity substances are included in the IPA solution or not, an erroneous injection of chemicals can be instantly determined and an accident caused from the chemicals can be immediately prevented.

As for an example of the organic solvent, IPA is exemplified, however, this solvent is illustrated only for an explanation because of its wide use in the semiconductor process. In addition to IPA, any solvent having polarity and similar characteristics with IPA can be applied. After repeated experiments by the inventors of the present invention, it can be confirmed that aqueous and saturated alcohol solvent such as methyl alcohol, ethyl alcohol, butyl alcohol, SC1 (a mixture of hydrogen peroxide, ammonium hydroxide and deionized water), various acid solutions of low concentration can be applied for the method of the present invention.

In addition to the semiconductor process, the apparatus of the present invention can be applied in various fields for detecting water quality, such as a detection of water quality from atomic power plants, a detection of water quality in a tank of an apartment house, and the like.

In the method for determining the metal ions of the present invention, the luminol sample, the hydrogen peroxide sample and the metal ion sample can be homogeneously mixed and the reactants therein completely react before being exhausted. Thus, an accurate quantitative analysis of trace amounts of the metal ions can be accomplished while exhibiting an excellent reproductiveness of the analysis procedure.

In addition, almost all the light emitted during the reaction can be effectively collected. That is, having the additional installation of the collecting apparatus further increases the accurate analysis of the metal ions. Further, the apparatus of the present invention can be manufactured at a low cost.

While the present invention is described in detail referring to the attached embodiment, various modifications, alternate constructions and equivalents may be employed without departing from the true spirit and scope of the present invention.

What is claimed is:

1. A method for determining a metal ion comprising the steps of:
independently introducing a first sample containing luminol and hydrogen peroxide and a second sample containing said metal ion into a predetermined space;
simultaneously moving said first and second samples introduced into said predetermined space at the same time along a channel in said predetermined space in order to start a reaction between them and emit light;
measuring intensity of said emitted light; and
treating said measured intensity to determine a concentration of said metal ion.

2. A method for determining a metal ion as claimed in claim 1, further comprising the step of collecting said emitted light.

3. A method for determining a metal ion as claimed in claim 2, further comprising the steps of:
amplifying said collected light; and
converting said amplified light into current.

4. A method for determining a metal ion as claimed in claim 1, wherein said first and second samples are respectively introduced into said predetermined space at each predetermined velocity.

5. A method for determining a metal ion as claimed in claim 4, wherein said velocity of said first sample is about 1-5 m/min and said velocity of said second sample is about 1-10 m/min.

6. A method for determining a metal ion as claimed in claim 1, wherein said first and second samples move along said channel while rotating.

7. A method for determining a metal ion as claimed in claim 1, wherein a retention time of said first and second samples in said predetermined space is at least 30 seconds.

8. A method for determining a metal ion as claimed in claim 1, wherein said metal ion is one selected from the group consisting of Fe(II), Cu(II), Cr(II) and Co(II).

9. A method for determining a metal ion as claimed in claim 1, wherein said concentration of said metal ion is about 0.01-5.00 ppm by weight.

10. A method for determining a metal ion as claimed in claim 1, wherein a solvent of said second sample is water, water-soluble and saturated alcohol of C₁-C₆ or a mixture thereof and wherein C₁-C₆ means carbon compounds having 1-6 carbons.

11. A method for determining a metal ion as claimed in claim 11, wherein said water-soluble and saturated alcohol is IPA (isopropyl alcohol).

12. A method for determining a metal ion comprising the steps of:
independently introducing a first sample containing luminol and hydrogen peroxide, and a second sample exhausted from a semiconductor process containing said metal ion and water-soluble and saturated alcohol of C₁-C₆ into a predetermined space, said C₁-C₆ meaning carbon compounds having 1-6 carbons;
moving said first and second samples along a channel in said predetermined space in order to mix said first and second samples to start a reaction between them and emit light;
exhausting a produced sample after completing said reaction;
measuring intensity of said emitted light; and
treating said measured intensity to determine a concentration of said metal ion.

13. A method for determining a metal ion as claimed in claim 12, wherein said water-soluble and saturated alcohol is IPA (isopropyl alcohol).

14. A method for determining a metal ion as claimed in claim 12, wherein said semiconductor process is a process of rinsing a developed pattern with a rinsing solution after completing a developing process during implementation of a photolithographic process.

15. An apparatus for determining a metal ion comprising:
a cell including two sample introducing tubes at a bottom portion of said cell, one sample exhausting tube at an upper portion of said cell and a pipe-shaped reaction tube of which diameter is about 1-10 times of a diameter of said sample introducing tube, said reaction tube passing emitted light while samples react therein;
a sensor for measuring an intensity of said emitted light; and
a controller for treating said measured intensity of said emitted light to obtain a concentration of said metal ion.

16. An apparatus for determining a metal ion as claimed in claim 15, further comprising:
a collector having a hemispherical shape for wrapping said cell, and a reflection layer being formed on an inner surface of said collector; and
a holder for supporting said collector including holes for passing said sample introducing tubes and said sample exhausting tube, said holder being made from a dielectric material.

17. An apparatus for determining a metal ion as claimed in claim 16, wherein said cell and said collector are made from quartz or sapphire.

18. An apparatus for determining a metal ion as claimed in claim 16, wherein said reflection layer is an aluminum layer or a silver paper.

19. An apparatus for determining a metal ion as claimed in claim 16, further comprising:
an amplifier for amplifying said collected light; and
a current converter for converting said amplified light into current.

20. An apparatus for determining a metal ion as claimed in claim 15, further comprising at least one syringe pump for introducing said sample into said reaction tube through said sample introducing tubes.

21. An apparatus for determining a metal ion as claimed in claim 15, wherein said reaction tube has a circularly integrated helical structure.

22. An apparatus for determining a metal ion as claimed in claim 21, wherein a diameter of a circle of said helical structure is in a range of about 1.5-1.9 cm, a height of said helical structure is in a range of about 1.9-2.3 cm, a diameter of said reaction tube is in a range of 3-50 mm and a diameter of said sample introducing tube is in a range of about 3-5 mm.

23. An apparatus for determining a metal ion as claimed in claim 16, wherein said holder is provided in a dark enclosure.
